(19) United States
(12) Patent Application Publication
(10) Pub. No.: US 2018/0349518 A1
(43) Pub. Date: Dec. 6, 2018

(54) SYSTEMS AND METHODS FOR IMPROVED PART INSPECTION

(71) Applicant: General Electric Company, Schenectady, NY (US)

(72) Inventors: Jason Anton Byers, Greenville, SC (US); Hoil Song, Greenville, SC (US); Mohamed Karim Baig, Bangalore (IN); Gerald D. Blow, Greer, SC (US); Brian Christopher Wheeler, Simpsonville, SC (US); James Stanley, Greenville, SC (US); John Madison Tramel, JR., Roebuck, SC (US); Alexandria Stoker Cochrane, Greenville, SC (US)

(21) Appl. No.: 15/608,642

(22) Filed: May 30, 2017

(51) Int. Cl. G06F 17/50

(52) U.S. Cl. CPC G06F 17/50; G05B 19/4097

(57) ABSTRACT

In one embodiment, a computer-aided technology (CAx) system includes a memory storing an inspection system. The CAx system further includes a processor communicatively coupled to the memory and configured to execute the inspection system to receive a computer aided design (CAD) model of a part design as input. The processor is additionally configured to execute the inspection system to provide a list of definitions included in the CAD model, and to iterate through the list to select a sublist of definitions for inspection. The processor is also configured to execute the inspection system to create an inspection model based on the sublist of definitions, and to create an inspection code, wherein the inspection code comprises instructions executable via an automated inspection system.

### BACKGROUND OF THE INVENTION

The subject matter disclosed herein relates to systems and methods for design and/or inspection of parts, such as machine parts.

Certain design and inspection techniques may be used to create a variety of machinery, including industrial machines. Industrial machines, such as gas turbine systems, may provide for the generation of power. For example, the gas turbine systems typically include a compressor for compressing a working fluid, such as air, a combustor for combusting the compressed working fluid with fuel, and a turbine for turning the combusted fluid into a rotative power. For example, the compressed air is injected into a combustor, which heats the fluid causing it to expand, and the expanded fluid is forced through the gas turbine. The gas turbine may then convert the expanded fluid into rotative power, for example, by a series of blade stages. The rotative power may then be used to drive a load, which may include an electrical generator producing electrical power and electrically coupled to a power distribution grid. Industrial machines and machine parts may be designed for a particular purpose, such as a compressor blade designed to compress air. The machine or part may then be inspected for its ability to fulfill its design purpose. It may be beneficial to improve the design and/or inspection of machine and machine parts.

### BRIEF DESCRIPTION OF THE INVENTION

Certain embodiments commensurate in scope with the originally claimed invention are summarized below. These embodiments are not intended to limit the scope of the claimed invention, but rather these embodiments are intended only to provide a brief summary of possible forms of the invention. Indeed, the invention may encompass a variety of forms that may be similar to or different from the embodiments set forth below.

In a first embodiment, a computer-aided technology (CAx) system includes a memory storing an inspection system. The CAx system further includes a processor communicatively coupled to the memory and configured to execute the inspection system to receive a computer aided design (CAD) model of a part design as input. The processor is additionally configured to execute the inspection system to provide a list of definitions included in the CAD model, and to iterate through the list to select a sublist of definitions for inspection. The processor is also configured to execute the inspection system to create an inspection model based on the sublist of definitions, and to create an inspection code, wherein the inspection code comprises instructions executable via an automated inspection system.

In a second embodiment, a method for applying a computer-aided technologies (CAx) system includes executing, via a processor, an inspection system to receive a computer aided design (CAD) model of a part design as input. The method further includes executing, via the processor, the inspection system to provide a list of definitions included in the CAD model, and to iterate through the list to select a sublist of definitions for inspection. The method also includes executing, via the processor, the inspection system to create an inspection model based on the sublist of definitions, and to create an inspection code, wherein the inspection code comprises instructions executable via an automated inspection system.

In a third embodiment, one or more tangible, non-transitory, machine-readable media including instructions that cause a processor to execute, via the processor, an inspection system to receive a computer aided design (CAD) model of a part design as input. The instructions are further configured to cause the processor to execute the inspection system to provide a list of definitions included in the CAD model, and to iterate through the list to select a sublist of definitions for inspection. The instructions are also configured to cause the processor to execute the inspection system to create an inspection model based on the sublist of definitions, and to create an inspection code, wherein the inspection code comprises instructions executable via an automated inspection system.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 is a block diagram of an embodiment of a computer-aided technology (CAx) system;

FIG. 2 is a block diagram of embodiments of certain components of the CAx system of FIG. 1, including an inspection system;

FIG. 3 is block diagram of an embodiment, of an industrial system that may be conceived, designed, engineered, manufactured, and/or service and tracked by the CAx system of FIG. 1; and

FIG. 4 is a flowchart of an embodiment of a process suitable for inspecting parts that have been designed via a CAD model.

### DETAILED DESCRIPTION OF THE INVENTION

One or more specific embodiments of the present invention will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present invention, the articles “a,” “an,” “the,” and “said” are intended to mean that there are one or more of the elements. The terms “comprising,” “including,” and “having” are intended to be inclusive and mean that there may be additional elements other than the listed elements.

Designing a machine or part may include certain systems and methods described in more detail below that produce a design for a part or product. For example, the design may be created as a model-based definition included in a 3-dimensional (3D) computer aided design (CAD) model and associated product and manufacturing information (PMI). The techniques described herein may not create typical engineering part drawing or drawings, as the CAD model and PMI may contain all part dimensional and tolerance information, as further described below.

Before inspection of the resulting design, the techniques described herein may enable a user to iterate through a model (e.g., 3D model, 2D model) and select one or more (or all) model definitions for inspection. The selected definition(s) may then be automatically edited to format the definition(s) for inspection. For example, general tolerances may be added, associated faces may be checked, and so on, as described in more detail below. An inspection program may then be automatically generated, such as program suitable for directing an inspection via a coordinate-measuring machine (CMM) system.

The inspection program may create an inspection model for the user, segregated by the different operations that the user has specified, and create all of the inspection objects selected in the 3D modeling software. Any 3D definition objects that were not successfully consumed by the operation may then be reported out to the user, along with an explanation report as to why they the objects were not consumed and how to fix the objects if possible. A user defined event may then been created, suitable for enabling the editing of post code that would then be created by the solid modeling platform to add additional code, for example, for more efficient import to a Dimensional Measuring Interface Standard (DMIS) system, such as PC-DMIS, of the exported code generated by the techniques described herein. This includes logic that will write commands into the exported code that the CMM system will execute and send the gathered data directly to a server for immediate use by supply chain, manufacturing, and/or engineering. The code may then be created by solid modeling software, e.g., CAD software, that generates a DMIS file which may then imported into PC-DMIS for use during inspection. Results of the inspection may then be used as feedback to variety of processes, such as supply chain processes, engineering processes, and manufacturing processes.

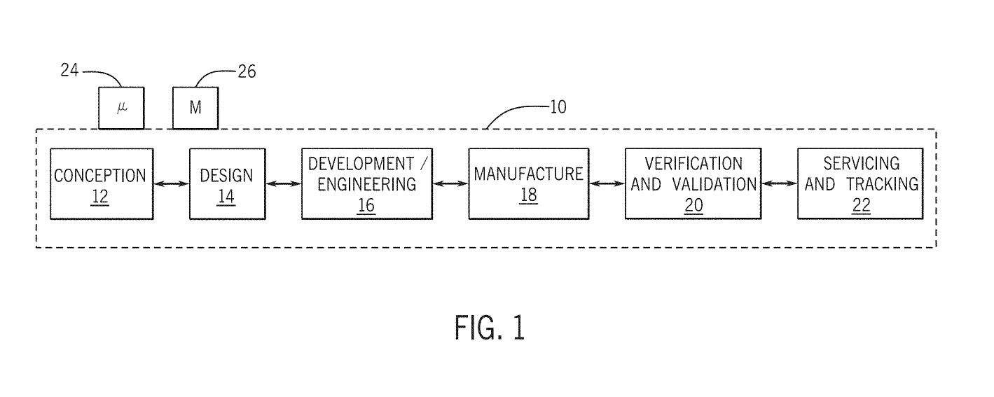

With the foregoing in mind, it may be useful to describe a computer-aided technologies (CAx) system that may incorporate the techniques described herein, for example suitable for executing one or more product lifecycle management (PLM) processes. Accordingly, FIG. 1 illustrates an embodiment of a CAx system 10 suitable for providing for a variety of processes, including PLM processes 12, 14, 16, 18, 20, 22. In the depicted embodiment, the CAx system 10 may include support for execution of conception processes 12. For example, the conception processes 12 may produce a set of specifications such as requirements specifications documenting a set of requirements to be satisfied by a design, a part, a product, or a combination thereof. The conception processes 12 may also produce a concept or prototype for the part or product (e.g., machinery, electronics, structures, or a combination thereof). A series of design processes 14 may then use the specifications and/or prototype to produce, for example, one or more 3D design models of the part or product. The 3D design models may include solid/surface modeling, parametric models, wireframe models, vector models, non-uniform rational basis spline (NURBS) models, geometric models, and the like, describing part geometries and structures. The PMI may include geometric dimensions, tolerances, text (e.g., annotations, notes), other dimensions, material type, material specifications, finishes (e.g., surface finishes), clearances, and so on, associated with the 3D models.

Design models may then be further refined and added to via the execution of development/engineering processes 16. The development/engineering processes may, for example, create and apply models such as thermodynamic models, low cycle fatigue (LCF) life prediction models, multibody dynamics (MBD) and kinematics models, computational fluid dynamics (CFD) models, finite element analysis (FEA) models, and/or 3-dimension to 2-dimension FEA mapping models that may be used to predict the behavior of the part or product during its operation. For example, turbine blades may be modeled to predict fluid flows, pressures, clearances, and the like, during operations of a gas turbine engine. The development/engineering processes 16 may additionally result in the tolerances, materials specifications (e.g., material type, material hardness), clearance specifications, and the like, useful in manufacturing the part or product and stored in the PMI.

The CAx system 10 may additionally provide for manufacturing processes 18 that may include manufacturing automation support. For example, additive manufacturing models may be derived, such as 3D printing models for material jetting, binder jetting, vat photopolymerization, powder bed fusion, sheet lamination, directed energy deposition, material extrusion, and the like, to create the part or product. Other manufacturing models may be derived, such as computer numeric control (CNC) models with G-code to machine or otherwise remove material to produce the part or product (e.g., via milling, lathing, plasma cutting, wire cutting, and so on). Bill of materials (BOM) creation, requisition orders, purchasing orders, and the like, may also be provided as part of the manufacture processes 18 (or other PLM processes).

The CAx system 10 may additionally provide for verification and/or validation processes 20 that may include automated inspection of the part or product as well as automated comparison of specifications, requirements, and the like. In one example, a coordinate-measuring machine (CMM) process may be used to automate inspection of the part or product. The CMM process may be aided by the use of an inspection system. For example, the inspection system may automatically generate inspection code that may then be used during inspection by the CMM process. The inspection system may enable the user to iterate through a model (e.g., 3D model, 2D model) and select one or more (or all) model definitions for inspection. The selected definition(s) may then be automatically edited to format the definition(s) for inspection. For example, general tolerances may be added, associated faces may be checked, and so on. An inspection program may then be automatically generated, such as program suitable for directing an inspection via the CMM process.

A servicing and tracking set of processes 22 may also be provided via the CAx system 10. The servicing and tracking processes 22 may log maintenance activities for the part, part replacements, part life (e.g., in fired hours), and so on. As illustrated, the CAx system 10 may include feedback between the processes 12, 14, 16, 18, 20, 22. For example, data from services and tracking processes 22, for example, may be used to redesign the part or product via the design processes 14. Indeed, data from any one of the processes 12, 14, 16, 18, 20, 22 may be automatically provided and used by any other of the processes 12, 14, 16, 18, 20, 22 to improve the part or product or to create a new part or a new product. In this manner, the CAx system 10 may incorporate data from downstream (or upstream) processes and use the data to improve the part or to create a new part.

The CAx system 10 may additionally include one or more processors 24 and a memory system 26 that may execute software programs to perform the disclosed techniques. Moreover, the processors 24 may include multiple microprocessors, one or more “general-purpose” microprocessors, one or more special-purpose microprocessors, and/or one or more application specific integrated circuits (ASICS), or some combination thereof. For example, the processors 24 may include one or more reduced instruction set (RISC) processors. The processors may additionally be included in a cloud-based system that provides for the processes 12, 14, 16, 18, 20, 22 as cloud-based services. The memory system 26 may store information such as control software, look up tables, configuration data, etc. The memory system 26 may include a tangible, non-transitory, machine-readable medium, such as a volatile memory (e.g., a random access memory (RAM)) and/or a nonvolatile memory (e.g., a read-only memory (ROM), flash memory, a hard drive, or any other suitable optical, magnetic, or solid-state storage medium, or a combination thereof).

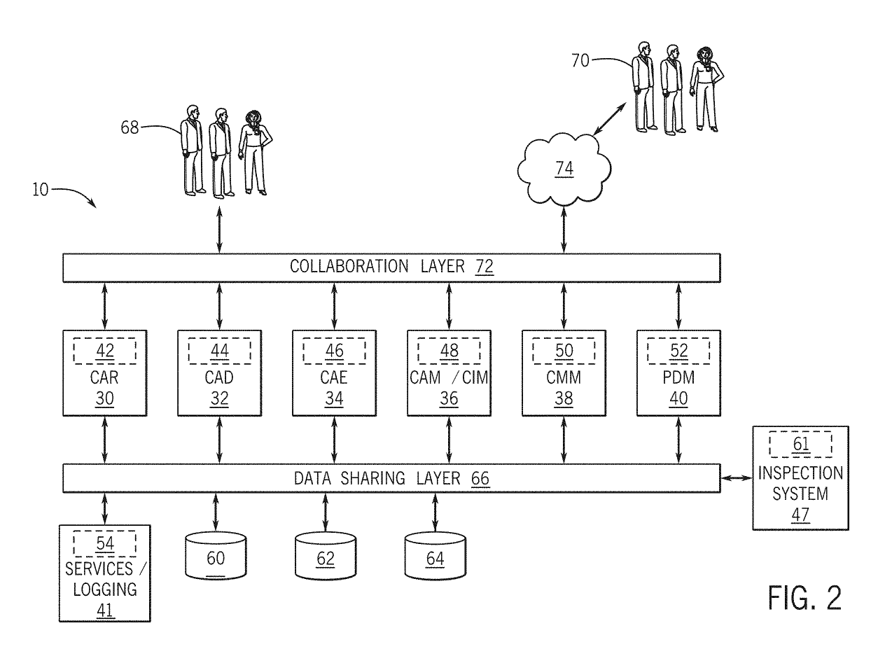

The memory system 26 may store a variety of information, which may be suitable for various purposes. For example, the memory system 26 may store machine-readable and/or processor-executable instructions (e.g., firmware or software) for the processors' 24 execution. In one embodiment, the executable instructions include instructions for a number of PLM systems, for example software systems, as shown in the embodiment of FIG. 2. More specifically, the CAx system 10 embodiment illustrates a computer-aided requirements capture (CAR) system 30, a computer-aided design (CAD) system 32, a computer-aided engineering (CAE) system 34, computer-aided manufacturing/computer-integrated manufacturing (CAM/CIM) system 36, a coordinate-measuring machine (CMM) system 38, and a product data management (PDM) system 40, a services/logging system 41, and inspection system 47. Each of the systems 30, 32, 34, 36, 38, 40, 41, and 47 may be extensible and/or customizable; accordingly, each system 30 may include an extensibility and customization system 42, 44, 46, 48, 50, 52, 54, and 61, respectively. Additionally, each of the systems 30, 32, 34, 36, 38, 40, 41, and 47 may be stored in a memory system, such as memory system 26, and may be executable via a processor, such as via processors 24.

In the depicted embodiment, the CAR system 30 may provide for entry of requirements and/or specifications, such as dimensions for the part or product, operational conditions that the part or product is expected to encounter (e.g., temperatures, pressures), certifications to be adhered to, quality control requirements, performance requirements, and so on. The CAD system 32 may provide for a graphical user interface suitable to create and manipulate graphical representations of 2D and/or 3D models as described above with respect to the design processes 14. For example, the 3D design models may include solid/surface modeling, parametric models, wireframe models, vector models, non-uniform rational basis spline (NURBS) models, geometric models, and the like. The CAD system 32 may provide for the creation and update of the 2D and/or 3D models and related information (e.g., views, drawings, annotations, notes, and so on). Indeed, the CAD system 32 may combine a graphical representation of the part or product with other, related information.

The CAE system 34 may enable creation of various engineering models, such as the models described above with respect to the development/engineering processes 16. For example, the CAE system 34 may apply engineering principles to create models such as thermodynamic models, low cycle fatigue (LCF) life prediction models, multibody dynamics (MBD) and kinematics models, computational fluid dynamics (CFD) models, finite element analysis (FEA) models, and/or 3-dimension to 2-dimension FEA mapping models. The CAE system 34 may then apply the aforementioned models to analyze certain part or product properties (e.g., physical properties, thermodynamic properties, fluid flow properties, and so on), for example, to better match the requirements and specifications for the part or product.

The CAM/CIM system 36 may provide for certain automation and manufacturing efficiencies, for example, by deriving certain programs or code (e.g., G-code) and then executing the programs or code to manufacture the part or product. The CAM/CIM system 36 may support certain automated manufacturing techniques, such as additive (or subtractive) manufacturing techniques, including material jetting, binder jetting, vat photopolymerization, powder bed fusion, sheet lamination, directed energy deposition, material extrusion, milling, lathing, plasma cutting, wire cutting, or a combination thereof. The CMM system 38 may include machinery to automate inspections. For example, probe-based, camera-based, and/or sensor-based machinery may automatically inspect the part or product to ensure compliance with certain design geometries, tolerances, shapes, and so on.

The PDM system 40 may be responsible for the management and publication of data from the systems 30, 32, 34, 36, 38, 40, 41, and/or 47. For example, the systems 30, 32, 34, 36, 38, 40, 41, and 47 may communicate with data repositories 60, 62, 64 via a data sharing layer 66. The PDM system 40 may then manage collaboration between the systems 30, 32, 34, 36, 38, 40, 41, and 47 by providing for data translation services, versioning support, data archive management, notices of updates, and so on. The PDM system 40 may additionally provide for business support such as interfacing with supplier/vendor systems and/or logistics systems for purchasing, invoicing, order tracking, and so on. The PDM system 40 may also interface with the service/logging system 41 (e.g., service center data management systems) to aid in tracking the maintenance and life cycle of the part or product as it undergoes operations. Teams 68, 70 may collaborate with team members via a collaboration layer 72. The collaboration layer 72 may include web interfaces, messaging systems, file drop/pickup systems, and the like, suitable for sharing information and a variety of data. The collaboration layer 72 may also include cloud-based systems 74 or communicate with the cloud-based systems 74 that may provide for decentralized computing services and file storage. For example, portions (or all) of the systems 30, 32, 34, 36, 38, 40, 41, and 47 may be stored in the cloud 74, be executable in the cloud 74, and/or accessible via the cloud 74.

The inspection system 47 system may be iterate through a model, such as a model produced via the CAD system 32, and select one or more (or all) model definitions for subsequent inspection. The selected definition(s) may then be automatically edited to format the definition(s) for inspection. In one example, general tolerances may be added, associated features such as faces, curvature, segments, meshes, holes, and so on, may be checked and modified if any discrepancies are found. An inspection program may then be automatically generated, such as program suitable for directing an inspection via a coordinate-measuring machine (CMM) system.

The inspection program may create an inspection model for the user, segregated by the different operations that the user has specified, and create all of the inspection objects selected in the 3D modeling software. Any 3D definition objects that were not successfully consumed by the operation may then be reported out to the user, along with an explanation report as to why they the objects were not consumed and how to fix the objects if possible. A user defined event may then been created, suitable for enabling the editing of post code that would then be created by the solid modeling platform to add additional code, for example, for more efficient import to a Dimensional Measuring Interface Standard (DMIS) system, such as PC DMIS, of the exported code generated by the techniques described herein. This includes logic that will write commands into the exported code that the CMM system 38 will execute and send the gathered data directly to a server for immediate use by supply chain, manufacturing, and/or engineering. The file(s) used to inspect may then created by the CAD system 32, which may include DMIS file(s) that may be imported into PC-DMIS. Data from inspection may then be sent to supply chain, manufacturing, and/or engineering process for supply of material and/or to provide feedback.

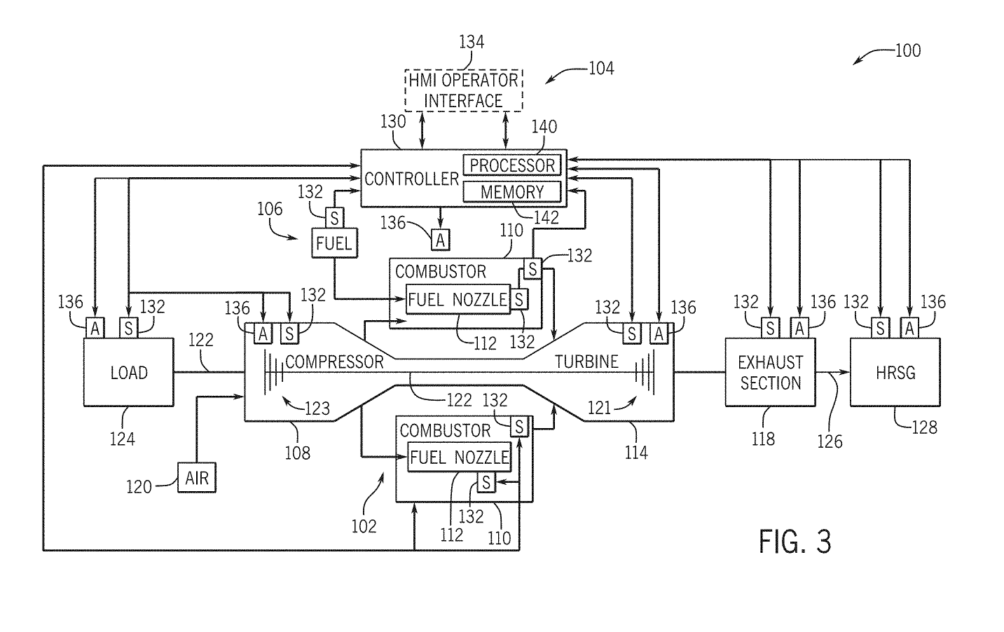

The services/logging system 41 may include shop systems that are used to service a variety of machinery, and that may thus log replacement of parts, track a specific part use in a specific device, track number of hours of use, track maintenance performed, and so on. In one embodiment, the services/logging system 41 may be fleet-based. That is, the services/logging system 41 may store and analyze data for a fleet of machinery, such as a fleet of power-production machinery described in more detail with respect to FIG. 3.

Once the design is updated, the part may then be manufactured and then inspected, for example via the CMM system 38. In one embodiment, the CMM system 38 may execute certain CMM inspection code For example, the code (e.g., dimensional measuring interface standard [DMIS] code, CALYPSO code) may include a set of locations on the part or product that the CMM system may inspect via a probe, a laser, a camera, and so on. The code may additionally include travel paths, a complete measurement plan, allowable variations, for example, in geometry, and so on. Results from the inspection may be used as input supply chain systems to provide for certain material, parts, and so on, used in manufacturing the inspected part. The results from the inspection may be further used to provide feedback to other processes, such as processes 12, 14, 16, 18, 20, 22.

The extensibility and customization systems 42, 44, 46, 48, 50, 52, 58 and 61 may provide for functionality not found natively in the CAR system 30, the CAD system 32, the CAM/CIM system 36, the CMM system 38, the PDM system 40, the services/logging system 41, and/or the inspection system 47. For example, computer code or instructions may be added to the systems 30, 32, 34, 36, 38, 40, 41, and 47 via shared libraries, modules, software subsystems and the like, included in the extensibility and customization systems 42, 44, 46, 48, 50, 52, 54, and/or 61. The extensibility and customization systems 42, 44, 46, 48, 50, 52, 54, and 61 may also use application programming interfaces (APIs) included in their respective systems 30, 32, 34, 36, 38, 40, 41, and 47 to execute certain functions, objects, shared data, software systems, and so on, useful in extending the capabilities of the CAR system 30, the CAD system 32, the CAM/CIM system 36, the CMM system 38, the PDM system 40, the services/logging system 41, and/or the inspection system 47. By enabling the processes 12, 14, 16, 18, 20, and 22, for example, via the systems 30, 32, 34, 36, 38, 40, 41, and 47 and their respective extensibility and customization systems 42, 44, 46, 48, 50, 52, 54, and 61, the techniques described herein may provide for a more efficient “cradle-to-grave” product lifecycle management.

It may be beneficial to describe a machine that would incorporate one or more parts manufactured and tracked by the processes 12, 14, 16, 18, 20, and 22, for example, via the CAx system 10. Accordingly, FIG. 3 illustrates an example of a power production system 100 that may be entirely (or partially) conceived, designed, engineered, manufactured, serviced, and tracked by the CAx system 10. As illustrated in FIG. 3, the power production system 100 includes a gas turbine system 102, a monitoring and control system 104, and a fuel supply system 106. The gas turbine system 102 may include a compressor 108, combustion systems 110, fuel nozzles 112, a gas turbine 114, and an exhaust section 118. During operation, the gas turbine system 102 may pull air 120 into the compressor 108, which may then compress the air 120 and move the air 120 to the combustion system 110 (e.g., which may include a number of combustors). In the combustion system 110, the fuel nozzle 112 (or a number of fuel nozzles 112) may inject fuel that mixes with the compressed air 120 to create, for example, an air-fuel mixture.

The air-fuel mixture may combust in the combustion system 110 to generate hot combustion gases, which flow downstream into the turbine 114 to drive one or more turbine stages. For example, the combustion gases may move through the turbine 114 to drive one or more stages of turbine blades 121, which may in turn drive rotation of a shaft system 122. The shaft system 122 may additionally be coupled to one or more compressor stages having compressor blades 123. The shaft 122 may additionally connect to a load 124, such as a generator that uses the torque of the shaft 122 to produce electricity. After passing through the turbine 114, the hot combustion gases may vent as exhaust gases 126 into the environment by way of the exhaust section 118. The exhaust gas 126 may include gases such as carbon dioxide (CO₂), carbon monoxide (CO), nitrogen oxides (NOₓ), and so forth.

The exhaust gas 126 may include thermal energy, and the thermal energy may be recovered by a heat recovery steam generation (HRSG) system 128. In combined cycle systems, such as the power plant 100, hot exhaust 126 may flow from the gas turbine 114 and pass to the HRSG 128, where it may be used to generate high-pressure, high-temperature steam. The steam produced by the HRSG 128 may then be passed through a steam turbine engine for further power generation. In addition, the produced steam may also be supplied to any other processes where steam may be used, such as to a gasifier used to combust the fuel to produce the untreated syngas. The gas turbine engine generation cycle is often referred to as the “topping cycle,” whereas the steam turbine engine generation cycle is often referred to as the “bottoming cycle.” Combining these two cycles may lead to greater efficiencies in both cycles. In particular, exhaust heat from the topping cycle may be captured and used to generate steam for use in the bottoming cycle.

In certain embodiments, the system 100 may also include a controller 130. The controller 130 may be communicatively coupled to a number of sensors 132, a human machine interface (HMI) operator interface 134, and one or more actuators 136 suitable for controlling components of the system 100. The actuators 136 may include valves, switches, positioners, pumps, and the like, suitable for controlling the various components of the system 100. The controller 130 may receive data from the sensors 132, and may be used to control the compressor 108, the combustors 110, the turbine 114, the exhaust section 118, the load 124, the HRSG 128, and so forth.

In certain embodiments, the HMI operator interface 134 may be executable by one or more computer systems of the system 100. A plant operator may interface with the industrial system 100 via the HMI operator interface 134. Accordingly, the HMI operator interface 134 may include various input and output devices (e.g., mouse, keyboard, monitor, touch screen, or other suitable input and/or output device) such that the plant operator may provide commands (e.g., control and/or operational commands) to the controller 130.

The controller 130 may include a processor(s) 140 (e.g., a microprocessor(s)) that may execute software programs to perform the disclosed techniques. Moreover, the processor 140 may include multiple microprocessors, one or more “general-purpose” microprocessors, one or more special-purpose microprocessors, and/or one or more application specific integrated circuits (ASICS), or some combination thereof. For example, the processor 140 may include one or more reduced instruction set (RISC) processors. The controller 130 may include a memory device 142 that may store information such as control software, look up tables, configuration data, etc. The memory device 142 may include a tangible, non-transitory, machine-readable medium, such as a volatile memory (e.g., a random access memory (RAM)) and/or a nonvolatile memory (e.g., a read-only memory (ROM), flash memory, a hard drive, or any other suitable optical, magnetic, or solid-state storage medium, or a combination thereof). As mentioned earlier, all systems, parts, components and so on, of

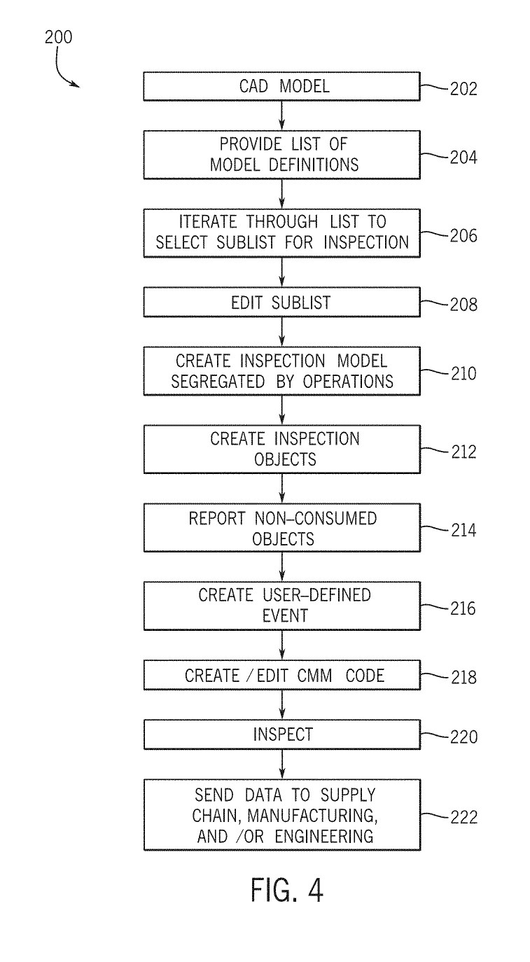

Turning now to FIG. 4, the figure is a flowchart illustrating a process 200 suitable for implementing the techniques described herein, including deriving an inspection code based on certain model definitions via the inspection system 47. The process 200 may be implemented as computer code or instructions stored in the memory 26 and executable via the processor 24. Additionally or alternatively, the process 200 may be implemented in hardware, such as in a custom chip, FPGA chip, and so on. Further, the process 200 may be executable via the cloud 74.

In the depicted embodiment, the process 200 may use a CAD model 202 as input to provide (block 204) a list of model 204 definitions. For example, the inspection system 47 may be used to display on a computing system display the list of model definitions such as a list of objects or components (e.g., parts, subparts) in the CAD model 202, such as model faces, exterior portions of parts, holes, portions of a part (e.g., top portion, side portion, bottom portion), and so on. The process 200 may then enable a user to iterate (block 206) through the list dot select on or more of the definitions, thus creating a sublist of model definitions to be used during inspection.

The process 200 may then enable the editing (block 206) of the sublist. For example, edited to format the definition(s) for inspection. For example, general tolerances may be added, associated features such as faces, curvature, segments, meshes, holes, and so on, may be checked and modified if any discrepancies are found. The process 210 may then create (block 210) an inspection model, which may be segregated by operations to be performed during inspection. For example, inspection operations such as tolerance inspection, material composition, coordinate measurements, inspection of geometries, and so on. Based on the inspection model, the process 200 may then create (block 212) one or more inspection objects. The inspection objects may be programmatic objects and/or CAD model 202 objects, for example, found in the edited sublist.

The process 200 may then report (block 214) non-consumed objects. For example, certain objects may include some errors or missing features (e.g., missing tolerances, missing geometries, missing measurements) and so on. Accordingly, the process 200 may report (block 214) these objects as not consumed for inspection purposes. The process 200 may then create (block 216) a user defined event. For example, the process 200 may enter a user-defined event into the CAD system 32 and/or inspection system 47 so that the event is “fired” during certain uses of systems 32/47, such as when inspections are desired. When the user-defined event is executed, for example by creating (block 218) CMM system 38 code (e.g., the CAD system 32 may be used to automatically create the CMM system 38 inspection code), event may trigger and the user may be provided facilities to add code to the CMM system 38 code, such as code that may result in a more smooth import into the CMM system 38. For example, certain CMM system 38 vendors may include features that enable certain inspection techniques and the like, in their CMM systems 38. Accordingly, the process 200 may enable the editing of CMM system 38 code (e.g., DMIS code) to use specific CMM systems 38 more efficiently and productively. The CMM system 38 code, for example, may inspect for nominal value, a plus/minus tolerance, a critical-to-quality (CTQ) type, a statistical process control (SPC) data, a verification (VER) data, a dimension type information comprising a basic, a circular, a chamfer, a degree, a diameter, a surface finish, a radius, a reference, a surface of revolution, a thread, or a combination thereof, a tolerance type information comprising an angularity, a concentricity, a flatness, a non-SPC dimension, a perpendicularity, a parallelism, a runout, a surface, a line profile, a true position, or a combination thereof, a unit of measure, or a combination thereof.

Once the CMM system 38 code has been created and/or edited (block 218), the process 200 may then inspect a part or parts (block 220). For example, the CMM system 38 may be used to execute the CMM system 38 code to inspect the part or parts that have been designed in the CAD model 202. For example, the CMM system 38 may include machinery to automate inspections. For example, probe-based, camera-based, and/or sensor-based machinery may automatically inspect the part or parts to ensure compliance with certain design geometries, tolerances, shapes, and so on, as detailed in the CMM system 38 code. Results of the inspection may then be sent (block 222) to supply chains suitable for procuring material for retail production of the part or parts, as well as to other processes such as conception 12, design 14, engineering 16, manufacturing 18, verification and validation 20, and/or service and tracking 22. By providing feedback to the aforementioned processes, the techniques described herein may enable more productive and efficient creation of parts, such as turbomachinery parts.

Technical effects include systems and methods for conceiving, designing, engineering, manufacturing, verifying, and/or servicing/tracking parts or products, such as turbomachinery parts or products. An inspection system is provided. The inspection system may enable a user to iterate through a model (e.g., CAD model) and select one or more (or all) model definitions for inspection. The selected definition(s) may then be automatically edited to format the definition(s) for inspection. An inspection program may then be automatically generated, such as program suitable for directing an inspection via a coordinate-measuring machine (CMM) system. The inspection program may create an inspection model for the user, segregated by the different operations that the user has specified, and create all of the inspection objects selected in the 3D modeling software. Any 3D definition objects that were not successfully consumed by the operation may then be reported out to the user, along with an explanation report as to why they the objects were not consumed and how to fix the objects if possible. A user defined event may then been created, suitable for enabling the editing of post code that would then be created by the solid modeling platform to add additional code, for example, for more efficient import to a Dimensional Measuring Interface Standard (DMIS) system. Result of the inspections may then be reported to provide feedback that may improve supply chains, manufacturing, and/or engineering processes.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

1. A computer-aided technologies (CAx) system, comprising:
a memory storing an inspection system; and
a processor communicatively coupled to the memory and configured to execute the inspection system to:
receive a computer aided design (CAD) model of a part design as input;
provide a list of definitions included in the CAD model;
iterate through the list to select a sublist of definitions for inspection;
create an inspection model based on the sublist of definitions; and
create an inspection code, wherein the inspection code comprises instructions executable via an automated inspection system.

2. The system of claim 1, wherein the processor is configured to execute the inspection system to create a user-defined event so that the event fires when the inspection code is created.

3. The system of claim 2, wherein the wherein the processor is configured to execute the inspection system to create a user-defined event in a CAD system configured to produce the CAD model.

4. The system of claim 3, wherein the CAD system is configured to automatically generate the inspection code, and wherein the user-defined event when fired provides for a user interface to edit the inspection code.

5. The system of claim 1, wherein the inspection code directs the automated inspection system to inspect for a nominal value, a plus/minus tolerance, a basic dimension, a circular dimension, a chamfer, a degree, a diameter, a surface finish, a radius, a reference, a surface of revolution, a thread, or a combination thereof; a tolerance type information comprising an angularity, a concentricity, a flatness, a perpendicularity, a parallelism, a runout, a surface, a line profile, a true position, or a combination thereof, a unit of measure, or a combination thereof.

6. The system of claim 1, wherein the processor is configured to execute the inspection system to send automated inspection system data to a supply chain, a manufacturing process, an engineering process, a design process, a conception process, a verification and validation process, a service and tracking process, or a combination thereof, after the automate inspection system inspects a part modeled via the CAD model.

7. The system of claim 1, wherein the processor is configured to execute the inspection system to derive one or more inspection objects that are not consumed for inspection and to report the one or more inspection objects.

8. The system of claim 1, wherein the automated inspection system comprises a probe-based system, a camera-based system, or a combination thereof, configured to automatically inspect a part modeled via the CAD model.

9. The system of claim 1, wherein the inspection code comprises a Dimensional Measuring Interface Standard (DMIS) code.

10. A method for applying a computer-aided technologies (CAx) system, comprising:
executing, via a processor, an inspection system to:
receive a computer aided design (CAD) model of a part design as input;
provide a list of definitions included in the CAD model;
iterate through the list to select a sublist of definitions for inspection;
create an inspection model based on the sublist of definitions; and
create an inspection code, wherein the inspection code comprises instructions executable via an automated inspection system.

11. The method of claim 10, comprising executing, via the processor, the inspection system to create a user-defined event so that the event fires when the inspection code is created.

12. The method of claim 10, comprising executing, via the processor, the inspection system to send automated inspection system data to a supply chain, a manufacturing process, an engineering process, a design process, a conception process, a verification and validation process, a service and tracking process, or a combination thereof, after the automate inspection system inspects a part modeled via the CAD model.

13. The method of claim 10, comprising executing, via the processor, the inspection system to derive one or more inspection objects that are not consumed for inspection and to report the one or more inspection objects.

14. The method of claim 10, wherein the automated inspection system comprises a probe-based system, a camera-based system, or a combination thereof, configured to automatically inspect a part modeled via the CAD model.

15. The method of claim 10, wherein the inspection code comprises a Dimensional Measuring Interface Standard (DMIS) code.

16. One or more tangible, non-transitory, machine-readable media comprising instructions configured to cause a processor to:
execute, via the processor, an inspection system to:
receive a computer aided design (CAD) model of a part design as input;
provide a list of definitions included in the CAD model;
iterate through the list to select a sublist of definitions for inspection;
create an inspection model based on the sublist of definitions; and
create an inspection code, wherein the inspection code comprises instructions executable via an automated inspection system.

17. The one or more machine-readable media of claim 16, comprising instructions configured to cause the processor to execute the inspection system to create a user-defined event so that the event fires when the inspection code is created.

18. The one or more machine-readable media of claim 16, comprising instructions configured to cause the processor to execute the inspection system to send automated inspection system data to a supply chain, a manufacturing process, an engineering process, a design process, a conception process, a verification and validation process, a service and tracking process, or a combination thereof, after the automate inspection system inspects a part modeled via the CAD model.

19. The one or more machine-readable media of claim 16, wherein the automated inspection system comprises a probe-based system, a camera-based system, or a combination thereof, configured to automatically inspect a part modeled via the CAD model.

20. The one or more machine-readable media of claim 16, wherein the inspection code comprises a Dimensional Measuring Interface Standard (DMIS) code.
